(19) United States
(12) Patent Application Publication
(10) Pub. No.: US 2026/0111483 A1
(43) Pub. Date: Apr. 23, 2026

(54) MUSIC INFORMATION RECOMMENDATION METHOD, ELECTRONIC DEVICE, AND STORAGE MEDIUM

(71) Applicant: Beijing Zitiao Network Technology Co., Ltd., Beijing (CN)

(72) Inventors: Bingjian YAN, Beijing (CN); Yu GAO, Beijing (CN); Yonghua ZHANG, Beijing (CN)

(21) Appl. No.: 19/367,327

(22) Filed: Oct. 23, 2025

(30) Foreign Application Priority Data
Oct. 23, 2024 (CN) 202411487662.6

(51) Int. Cl. G06F 16/638; G06F 16/64

(52) U.S. Cl. CPC G06F 16/638; G06F 16/64

(57) ABSTRACT

The present disclosure provides a music information recommendation method and apparatus, a device, a medium, and a program product. The music information recommendation method includes: displaying a comprehensive search page in response to a search instruction for a piece of music information; and displaying a first search result page in response to an input instruction for search information on the comprehensive search page, where the first search result page is used to display a plurality of types of music cards, the music cards include a plurality of music resources, and a display order of the music cards is determined based on the types of the music cards and features of the plurality of music resources.

### CROSS-REFERENCE TO RELATED APPLICATION

The present application claims the priority to Chinese Patent Application No. 202411487662.6, filed on Oct. 23, 2024, the entire disclosure of which is incorporated herein by reference as portion of the present application.

### TECHNICAL FIELD

The present disclosure relates to a music information recommendation method and apparatus, a device, a medium, and a program product.

### BACKGROUND

In a comprehensive search page of a music scene, when a search term is given, search results are displayed on the result page in the form of cards. The result page includes a rich variety of card types. It is generally difficult to display these cards on the same page, and a page needs to be pulled down to display the cards. In this process, how to display cards of different types in an order is involved, and the display order is related to recommendation accuracy. Therefore, how to improve the recommendation accuracy of music information is an urgent problem to be solved.

### SUMMARY

The present disclosure provides a music information recommendation method and apparatus, a device, a medium, and a program product.

The present disclosure provides a music information recommendation method, and the method includes:
displaying a comprehensive search page in response to a search instruction for a piece of music information; and
displaying a first search result page in response to an input instruction for search information on the comprehensive search page, where the first search result page is used to display a plurality of types of music cards, the music cards include a plurality of music resources, and a display order of the music cards is determined based on the types of the music cards and features of the plurality of music resources.

The present disclosure provides a music information recommendation apparatus, and the apparatus includes:
a search instruction response module, configured to display a comprehensive search page in response to a search instruction for a piece of music information; and
a search result display module, configured to display a first search result page in response to an input instruction for search information on the comprehensive search page, where the first search result page is used to display a plurality of types of music cards, the music cards include a plurality of music resources, and a display order of the music cards is determined based on the types of the music cards and features of the plurality of music resources.

The present disclosure provides an electronic device, including a memory and a processor; the memory and the processor are in communication connection with each other, the memory stores computer instructions, and the processor is configured to execute the computer instructions to perform the music information recommendation method.

The present disclosure provides a computer-readable storage medium having computer instructions stored thereon, and the computer instructions are used to enable a computer to perform the music information recommendation method.

The present disclosure provides a computer program product including computer instructions, and the computer instructions are used to enable a computer to perform the music information recommendation method.

### BRIEF DESCRIPTION OF DRAWINGS

In order to illustrate the technical solutions in the embodiments of the present disclosure or in the related art more clearly, the drawings required for describing the embodiments or the related art will be briefly described below. Obviously, the drawings in the following description show some embodiments of the present disclosure, and a person of ordinary skill in the art may still derive other drawings from these drawings without creative efforts.

FIG. 1 is a schematic flowchart of a music information recommendation method according to the embodiments of the present disclosure;

FIG. 2 is a schematic diagram of a first search result page in a music information recommendation method according to the embodiments of the present disclosure;

FIG. 3 is a schematic diagram of sliding a music card on a first search result page in a music information recommendation method according to the embodiments of the present disclosure;

FIG. 4 is a schematic flowchart of obtaining a target point ranking model in a music information recommendation method according to the embodiments of the present disclosure;

FIG. 5 is another schematic flowchart of obtaining a target point ranking model in a music information recommendation method according to the embodiments of the present disclosure;

FIG. 6 is a schematic block diagram of a structure of a music information recommendation apparatus according to the embodiments of the present disclosure; and

FIG. 7 is a schematic diagram of a hardware structure of an electronic device according to the embodiments of the present disclosure.

### DETAILED DESCRIPTION

In order to make the objectives, technical solutions, and advantages of the embodiments of the present disclosure clearer, the technical solutions in the embodiments of the present disclosure will be clearly and completely described below with reference to the drawings in the embodiments of the present disclosure. Obviously, the described embodiments are a part of the embodiments of the present disclosure, but not all of them. All other embodiments obtained by a person of ordinary skill in the art based on the embodiments in the present disclosure without creative efforts shall fall within the protection scope of the present disclosure.

It may be understood that, before using the technical solutions disclosed in the embodiments of the present disclosure, the user should be informed of and grant authorization for the type, usage range, usage scenario, etc. of personal information involved in the present disclosure in an appropriate manner according to relevant laws and regulations.

For example, when receiving an active request from a user, a prompt message is sent to the user, to explicitly prompt the user that the operation requested to be performed will require acquisition and use of the user's personal information. In this manner, the user may independently select, according to the prompt message, whether to provide personal information to software or hardware such as an electronic device, an application, a server, or a storage medium that performs the operation of the technical solution of the present disclosure.

As an optional but non-limiting implementation, the manner of sending the prompt message to the user in response to receiving the active request from the user may be, for example, a pop-up window, and the prompt message may be presented in the pop-up window in the form of text. In addition, the pop-up window may also carry a selection control for the user to select “agree” or “disagree” to provide personal information to the electronic device.

It may be understood that, the above process of notifying and acquiring the user's authorization is only illustrative, and does not constitute a limitation on the implementations of the present disclosure, and other manners that satisfy relevant laws and regulations may also be applied to the implementations of the present disclosure.

It may be understood that, data involved in the technical solution (including but not limited to the data itself, and acquisition or use of the data) should comply with requirements of corresponding laws, regulations, and related provisions.

According to the embodiments of the present disclosure, an embodiment of a music information recommendation method is provided. It should be noted that, steps shown in the flowcharts may be executed in a computer system such as a set of computer-executable instructions, and although a logical order is shown in the flowcharts, in some cases, steps shown or described may be performed in a different order.

In the related art, the following solutions are usually used to determine the display order of music cards. In a first solution, several music resources ranking in top order in each music card are weighted, and the music cards are ranked according to weighted scores. However, the number of music resources included in different music cards is different, so the weighted scores cannot fully represent the actual situation of the music cards, and the recommendation accuracy of music information is relatively low. In a second solution, a listwise-based Light Gradient Boosting Machine (LGB) model is used to determine the display order of music cards. However, the LGB model is an offline model, and cannot dynamically adapt to changes of music cards, so the recommendation accuracy of music information still needs to be improved.

Based on this, the present disclosure provides a music information recommendation method. The comprehensive search page is displayed in response to a search instruction for a piece of music information; and a search result page is displayed in response to an input instruction for search information on the comprehensive search page, the first search result page is used to display a plurality of types of music cards, the music cards include a plurality of music resources, and the display order of the music cards is determined based on the types of the music cards and the features of the plurality of music resources. In this manner, various factors related to music information recommendation of the music cards are comprehensively considered in combination with the features of the music resources in the music cards, to obtain the display order, and the music cards are displayed on the first search result page according to the display order, thereby improving the recommendation accuracy of music information on the first search result page.

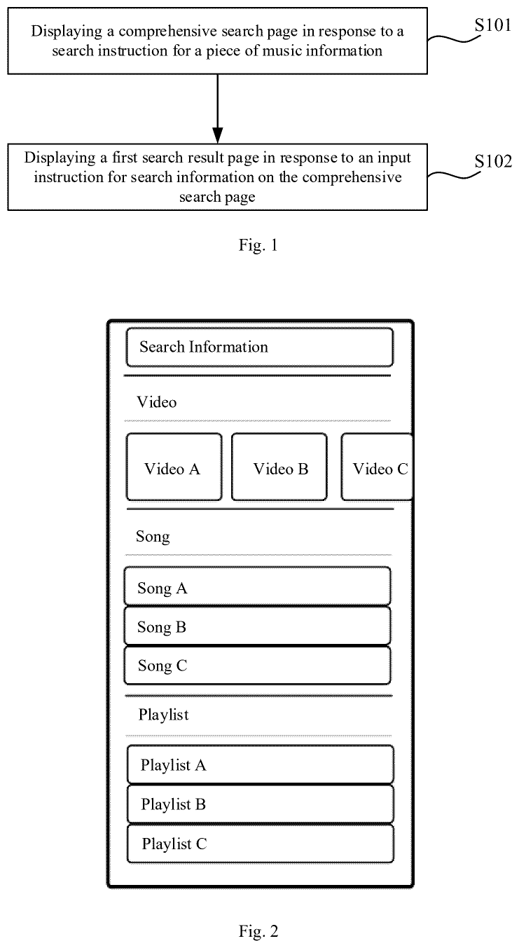

In the present embodiment, a music information recommendation method is provided, which may be used in music-related software or applications. FIG. 1 is a schematic flowchart of a music information recommendation method according to the embodiments of the present disclosure. As shown in FIG. 1, the process includes the following steps.

Step S101, displaying a comprehensive search page in response to a search instruction for a piece of music information.

In the embodiments of the present disclosure, the search instruction for music information is an instruction generated by triggering a search for a music resource. The comprehensive search page is displayed in response to the search instruction for music information, to provide the user with a platform for searching for music resources. The comprehensive search page is an information search page integrating a plurality of information types and information sources. The comprehensive search page integrates music resources of a plurality of types and sources, and a related music resource can be searched for by inputting search information on the comprehensive search page.

In an optional implementation, the search for the music resource may be triggered by triggering a search control corresponding to the music resource. The search control may be in the form of a search key, a search box, or the like, which is not specifically limited here.

In an optional implementation, the comprehensive search page may display frequently-used search information or frequently-used search keywords. In response to the frequently-used search information or the frequently-used search keyword being triggered, the triggered frequently-used search information or frequently-used search keyword is filled into the search information input interface on the comprehensive search page, so that the user can conveniently input the search information. The search information or search keyword that appears in the historical search information at a frequency or a number of times exceeding a preset value is selected through data statistics and analysis of the historical search information, and displayed on the comprehensive search page.

Step S102, displaying a first search result page in response to an input instruction for search information on the comprehensive search page.

In the embodiments of the present disclosure, the first search result page is used to display a plurality of types of music cards, and a music card includes a plurality of music resources. The type of a music resource included in each music card is consistent with the type of the music card where the music resource is located, and the types of the music resources included in the music cards of different types are also different. For example, for a music card of a video type, the type of a music resource included therein is also the video type; and for a music card of a song type, the type of a music resource included therein is also the song type. The music cards displayed on the first search result page are music cards associated with the search information input in the comprehensive search page, and the display order of the music cards is related to the relevance between the music resources in the music cards and the search information. The display order of the music cards is determined based on the type of the music cards and the features of the plurality of music resources.

In an optional embodiment, the input instruction for the search information on the comprehensive search page may be generated by triggering an input completion control of the search information. For example, the input completion control may be set in the search information input interface, and the input completion control may be triggered by clicking the input completion control, or by triggering a key or an icon associated with the input completion control, for example, associating the input completion control with an Enter key on a keyboard, and triggering the input completion control when the Enter key is triggered, to generate the input instruction for the search information. When the user completes inputting the search information, the input completion control is triggered to generate the input instruction for the search information; in response to the input instruction for the search information, music resources related to the search information is searched for on the comprehensive search page, and the related music resources are arranged and displayed in corresponding music cards respectively; and the music cards involved are displayed on the first search result page, to display search results corresponding to the search information to the user.

In an optional embodiment, a plurality of music resources included in the music cards are arranged and displayed in the corresponding music cards respectively, and different types of music cards use different arrangement manners to arrange the music resources. Specifically, if the type of a music card is a video type, a plurality of music resources are displayed in the music card in a first arrangement manner; and if the type of a music card is another type, such as a song type, a musician type, an album type, a playlist type, or the like, a plurality of music resources are displayed in the music card in a second arrangement manner. In this manner, the arrangement layout of the music resources in the music cards is more reasonable, which is convenient for the user to view the search results, and makes the layout of the first search result page more reasonable and beautiful.

In an embodiment, FIG. 2 is a schematic diagram of a first search result page in a music information recommendation method according to the embodiments of the present disclosure. As shown in FIG. 2, a first arrangement manner corresponding to a video-type music card is horizontal arrangement, that is, a plurality of video resources such as video resource A, video resource B, and video resource C are arranged horizontally in the video-type music card. A second arrangement manner corresponding to other types of music cards is vertical arrangement. Taking a song-type music card as an example, a plurality of music resources such as song resource A, song resource B, and song resource C are arranged vertically in the music card. FIG. 3 is a schematic diagram of sliding a music card on a first search result page in a music information recommendation method according to the embodiments of the present disclosure. As shown in FIG. 3, corresponding to the arrangement manner in FIG. 2, for a music card of a video type, a plurality of music resources in the music card may be displayed by means of horizontal sliding, that is, the video resource D arranged after the video resource C may be displayed by horizontally sliding the music card. For a music card of another type, a plurality of music resources in the music card may be displayed by means of vertical sliding. Still taking a song-type music card as an example, the song resource D arranged after the song resource C may be displayed by vertically sliding the music card.

In an optional embodiment, the feature of the music resource includes playback information of the music resource, and the playback information is used to update the display order of the music cards on the first search result page. The playback information represents the number of times the corresponding music resource is played in the music card, and the playback information is accumulated and counted according to the number of times the corresponding music resource is played, so as to improve the accuracy of subsequently determining the display order of the music cards, thereby improving the recommendation accuracy of music information. For a music card of a video type, the music resource included therein is also a video resource. When the video resource is played, the played video resource may be switched by means of a playback switch instruction, and the number of times the switched video resource is played increases. However, because the switched video resource is not directly played from the music card, this playback cannot represent the number of times the video resource is played in the music card, and therefore the playback should not be counted into the playback information, that is, the playback information is not updated at this time, so that the update to the playback information is more in line with the interaction of the first search result page.

Specifically, if the types of the music cards include a video type, a first video resource in the music cards is played on a playback page in response to a playback instruction for the first video resource, and the playback information of the first video resource is updated, where the first video resource is a video resource directly played in the music cards, and may be any video resource arranged in the music cards. A second video resource is played on the playback page in response to a playback switch instruction on the playback page, and the playback information of the second video resource is kept unchanged, where the second video resource is a switched video resource for playback, which may be a video resource arranged in the music cards, or may be a video resource associated with the first video resource, for example, a video resource in a video recommendation list associated with the first video resource.

In an optional embodiment, if a music resource in a music card of another type is playing on the playback page, it may also respond to the playback switch instruction on the playback page to switch the music resource to be played, similar to the above-mentioned music card of the video type, the playback information of the music resource is updated only when the playback instruction for the music resource in the music card is responded to, and the playback information is kept unchanged when the playback switch instruction on the playback page is responded to.

The music information recommendation method provided in the present disclosure determines the display order of the music cards based on the types of the music cards and the features of a plurality of music resources in the music cards. In this manner, various factors related to music information recommendation of the music cards are comprehensively considered in combination with the features of the music resources in the music cards, to obtain the display order, and the music cards are displayed on the first search result page according to the display order, thereby improving the recommendation accuracy of music information on the first search result page.

In an optional embodiment, the display order of the music cards is determined based on a target point ranking model, and the target point ranking model is determined based on the type of a sample music card and features of a plurality of sample music resources in the sample music card. The target point ranking model may be a model constructed based on a pointwise model, which independently evaluates and predicts a score or a probability of each piece of input data, ranks according to the score or the probability, and outputs a ranking result. The target point ranking model is constructed using the pointwise model, and only focuses on the absolute score of each feature of the music resource, without correlating the features of the music resource, so that the display order of the music card can be determined quickly and accurately.

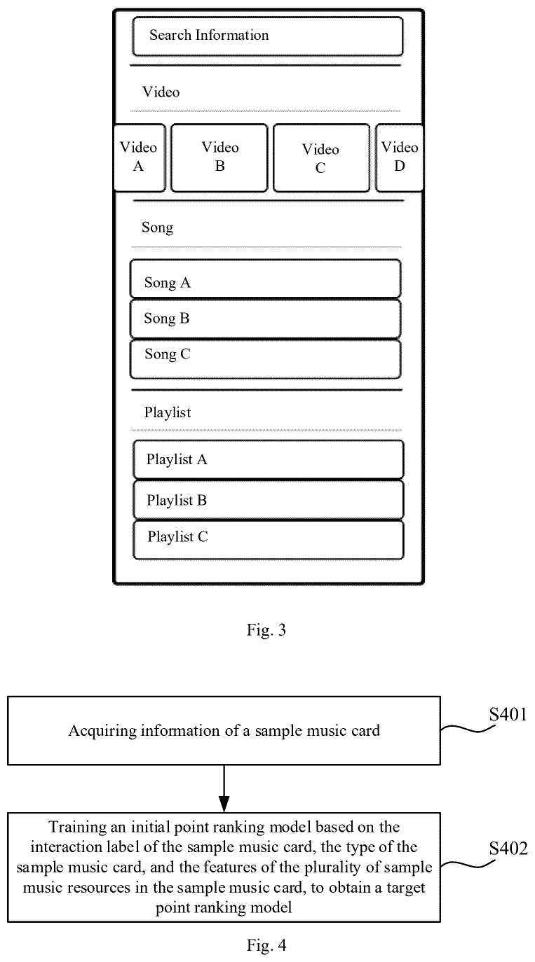

In an optional embodiment, the target point ranking model is obtained by training an initial point ranking model with a sample music card. FIG. 4 is a schematic flowchart of obtaining a target point ranking model in a music information recommendation method according to the embodiments of the present disclosure. As shown in FIG. 4, the target point ranking model is obtained based on the following steps.

Step S401, acquiring information of a sample music card.

In the embodiments of the present disclosure, the information of the sample music card includes an interaction label, the type of the sample music card, and features of a plurality of sample music resources in the sample music card. The interaction label is used to represent whether the sample music resources in the sample music card include a piece of interaction information, and the features of the sample music resources include the relevance between the sample music resources and corresponding historical search information, and playback information of the sample music resources.

In the embodiments of the present disclosure, the interaction information is used to represent whether the sample music resources are played in the sample music card. If the sample music resources are played in the sample music card, the sample music resources have interaction information; and if the sample music resources are not played in the sample music card, the sample music resources do not have interaction information. The interaction label of the sample music card is determined according to whether the sample music resources in the sample music card have interaction information. Specifically, if there is a sample music resource with interaction information in the sample music card, the label value of the interaction label of the sample music card is a first preset value; and if all the sample music resources in the sample music card do not have interaction information, the label value of the interaction label of the sample music card is a second preset value.

In the embodiments of the present disclosure, the type of the sample music card may be represented by one-hot encoding. Each type of the sample music card corresponds to one encoded feature in the one-hot encoding, and the number of encoded features in the one-hot encoding represents the number of types of the sample music cards involved. For example, if there are sample music cards of video, song, and album types, the sample music card of the video type may be represented by a one-hot encoding of 100, the sample music card of the song type may be represented by a one-hot encoding of 010, and the sample music card of the album type may be represented by a one-hot encoding of 001.

In an optional embodiment, the number of encoded features included in the one-hot encoding may dynamically change according to the number of types of music cards involved, that is, during the training process of the initial point ranking model or during the usage process of the target point ranking model, if one or more types of music cards are added, a corresponding number of encoded features are added to the one-hot encoding, and the one-hot encodings of other music cards are updated synchronously, thereby realizing the expandability of the music cards, so that the recommendation of music information can be extended and new types of music resources can be introduced. Taking the above as an example, if a sample music card of a playlist type is continued to be added, one bit of encoded feature is added to the one-hot encoding, and in this case, the sample music card of the video type is represented by a one-hot encoding of 1000, the sample music card of the song type is represented by a one-hot encoding of 0100, the sample music card of the album type is represented by a one-hot encoding of 0010, and the sample music card of the playlist type is represented by a one-hot encoding of 0001.

In the embodiments of the present disclosure, the relevance between the sample music resources and the corresponding historical search information is used to represent the degree of association between the sample music resources and the historical search information, which may be reflected by an association value. The association value is a numerical value within a set range, the larger the numerical value, the higher the degree of association between the sample music resources and the historical search information, and the smaller the numerical value, the lower the degree of association between the sample music resources and the historical search information.

In the embodiments of the present disclosure, the playback information of the sample music resources is used to represent the number of times the corresponding music resources are played in the music card, and the playback information is accumulated and counted according to the number of times the corresponding music resources are played.

In an optional embodiment, the features of the sample music resources further include the authority of the sample music resources, and the authority of the sample music resources is used to represent the credibility and reliability of the sample music resources, which may be quantitatively represented by information such as the number of likes and the complete playback rate of the sample music resources.

Step S402, training an initial point ranking model based on the interaction label of the sample music card, the type of the sample music card, and the features of the plurality of sample music resources in the sample music card, to obtain a target point ranking model.

In the embodiments of the present disclosure, the type of the sample music card and the features of the sample music card are used as input features of the initial point ranking model, and the output of the initial point ranking model is fitted with the interaction label of the sample music card, to train the initial point ranking model, to obtain the target point ranking model.

In the music information recommendation method provided in the present disclosure, the interaction label, the type, and the features of a plurality of sample music resources in the sample music card are used as the information of the sample music card, and the initial point ranking model is trained based on the information of the sample music card, to obtain the target point ranking model, so that the target point ranking model can predict and rank the interaction label of the music card according to the type of the music card and the features of the music resources therein, to obtain the display order of the music card.

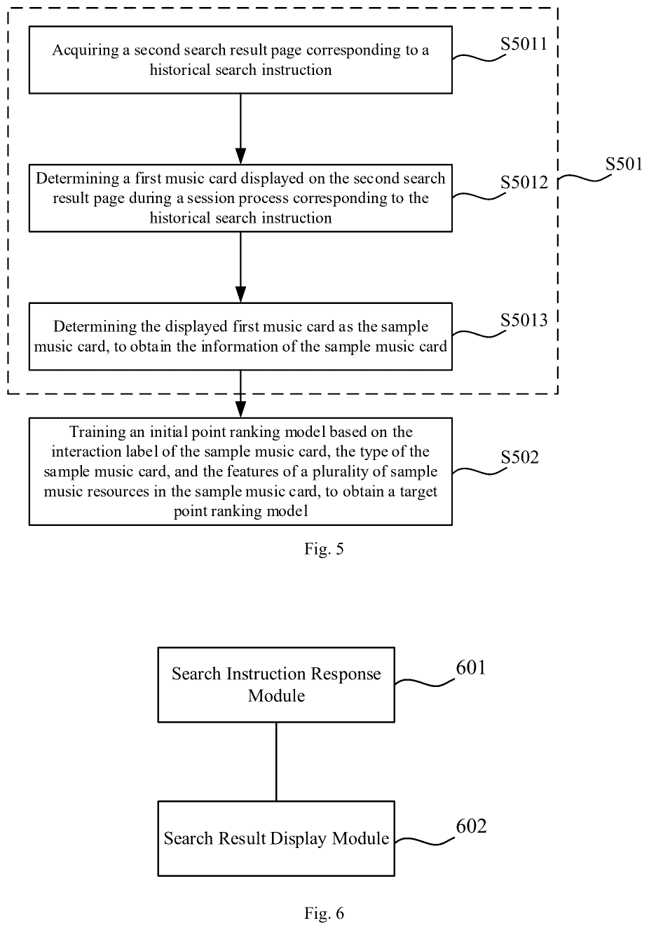

In an optional embodiment, FIG. 5 is another schematic flowchart of obtaining a target point ranking model in a music information recommendation method according to the embodiments of the present disclosure. As shown in FIG. 5, the target point ranking model is obtained based on the following steps.

Step S501, acquiring information of a sample music card.

Specifically, step S501 includes the following steps.

Step S5011, acquiring a second search result page corresponding to a historical search instruction.

In the embodiments of the present disclosure, all search instructions within a past period of time are acquired and used as historical search instructions, and second search result pages displayed in response to the respective historical search instructions are acquired respectively. A sample music card is determined according to the music cards displayed on the second search result page, to obtain the information of the sample music card.

Step S5012, determining a first music card displayed on the second search result page during a session process corresponding to the historical search instruction.

In the embodiments of the present disclosure, the second search result page includes a plurality of music cards. During the session process corresponding to the historical search instruction, not all music cards on the second search result page are displayed, and a music card is displayed when the second search result page slides to a position corresponding to the music card. If a music card is not displayed during the session process corresponding to the historical search instruction, it indicates that the music card is not concerned by the user, and is invalid negative sample data. If a music card is displayed during the session process corresponding to the historical search instruction, it indicates that the music card is concerned by the user, and is valid positive sample data. Therefore, the first music card displayed during the session process corresponding to the historical search instruction is acquired.

Step S5013, determining the displayed first music card as the sample music card, to obtain the information of the sample music card.

In the embodiments of the present disclosure, the first music card displayed on the second search result page is used as positive sample data, and the music card not displayed on the second search result page is used as negative sample data. Only the first music card is determined as the sample music card, and the music card not displayed is discarded at the same time, that is, the positive sample data is retained while the negative sample data is discarded, to reduce invalid data during the training process of the initial point ranking model, thereby improving the effectiveness of data processing and model training while reducing the amount of data processing.

In the embodiments of the present disclosure, the interaction label, the type, and the features of a plurality of sample music resources in the sample music card are acquired, to obtain the information of the sample music card.

In an optional embodiment, because there may be a sample music resource with invalid interaction in the sample music card, which may lead to a misjudgment of the interaction label of the sample music card, when obtaining the information of the sample music card in step S5013, the interaction effectiveness of the sample music resource needs to be confirmed, to improve the accuracy of the interaction label of the sample music card, thereby improving the accuracy of training the initial point ranking model, and then improving the reliability of the target point ranking model. Whether the sample music resource is invalid interaction may be determined by the playback duration of the sample music resource. If the playback duration of the sample music resource does not reach a preset playback duration, it indicates that the sample music resource is invalid interaction; and if the playback duration of the sample music resource reaches the preset playback duration, it indicates that the sample music resource is valid interaction.

Specifically, in response to determining that a first resource being played exists in the sample music card, the playback duration of the first resource is acquired. The interaction effectiveness of the first resource is determined based on the playback duration, and when the playback duration reaches the preset playback duration, the interaction effectiveness of the first resource is determined to be valid interaction. A label value of the interaction label of the sample music card is determined based on the interaction effectiveness of the first resource, that is, when the interaction effectiveness of the first resource is valid interaction, the label value of the interaction label of the sample music card is determined to be the first preset value, and when there is no first resource whose interaction effectiveness is valid interaction in the sample music card, the label value of the interaction label of the sample music card is determined to be the second preset value.

In an optional embodiment, during the process of obtaining the information of the sample music card in step S5013, before acquiring the features of a plurality of sample music resources in the sample music card, first, a preset number of music resources ranking in top order in the sample music card are determined, and the preset number of music resources ranking in top order are determined as the plurality of sample music resources in the sample music card, to obtain the features of the sample music resources. Because in the sample music card, the higher the ranking of a music resource, the higher the playback probability of the music resource, that is, the more times the playback information of the music resource ranking in top order corresponds to, the stronger the effectiveness of the feature data of the music resource ranking in top order, only the preset number of music resources ranking in top order are retained as positive sample data, and other music resources are discarded. That is, the preset number of music resources ranking in top order are used as the sample music card, and furthermore, when determining the display order of the music card according to the target point ranking model, only the features of the preset number of music resources ranking in top order are acquired, so as to extract effective music resource data, to reduce the amount of data processing while improving the effectiveness of data processing.

Step S502, training an initial point ranking model based on the interaction label of the sample music card, the type of the sample music card, and the features of a plurality of sample music resources in the sample music card, to obtain a target point ranking model. For details, reference may be made to step S402 of the embodiment shown in FIG. 4, which will not be repeated here.

In an optional embodiment, in the above-mentioned steps S501 and S502, the information of the sample music card is acquired according to the second search result page corresponding to the historical search instruction to train the initial point ranking model, and the obtained target point ranking model is an offline model, which will not be updated according to music cards subsequently displayed for a new search instruction. Therefore, after obtaining the target point ranking module, a second music card displayed on the comprehensive search page is further acquired, to obtain the information of the second music card, and the target point ranking model is updated based on the information of the second music card, to obtain an updated point ranking model. In this manner, online update of the target point ranking model is realized, and the recommendation accuracy of music information is improved.

As an application example of the embodiments of the present invention, taking the first search result page shown in FIG. 2 as an example, when the user triggers a search instruction for the music information, the search instruction for the music information is responded to, and a comprehensive search page is displayed to provide the user with a window for inputting search information. When the user completes inputting the search information, in response to the input instruction for the search information on the comprehensive search page, a search is performed on the comprehensive search page based on the input search information, to obtain search results, that is, a plurality of music resources of respective music cards. The features of the top three music resources ranked in the respective music cards are input into the target point ranking model, to obtain the display order of the music cards. In the embodiment shown in FIG. 2, the display order of the music cards is: video, song, and playlist. On the first search result page, the music cards are displayed according to the obtained display order, and the music resources therein are displayed in the respective music cards according to the corresponding arrangement manner, that is, the music resources therein are arranged horizontally in the video-type music card, and the music resources therein are arranged vertically in the song-type and playlist-type music cards.

The embodiments of the present disclosure further provide a music information recommendation apparatus. The apparatus is configured to implement the above-mentioned embodiments, and details will not be repeated here. As used below, the term “module” may implement a combination of software and/or hardware for a predetermined function. Although the apparatus described in the following embodiments is preferably implemented in software, the implementation in hardware, or a combination of software and hardware is also possible and contemplated.

The embodiments of the present disclosure provide a music information recommendation apparatus, as shown in FIG. 6, including:
a search instruction response module 601, configured to display a comprehensive search page in response to a search instruction for a piece of music information; and
a search result display module 602, configured to display a first search result page in response to an input instruction for search information on the comprehensive search page, where the first search result page is used to display a plurality of types of music cards, the music cards include a plurality of music resources, and a display order of the music cards is determined based on the types of the music cards and features of the plurality of music resources.

In an optional embodiment, if the type of the music card is a video type, the apparatus further includes:
a video resource playback module, configured to play a first video resource on a playback page in response to a playback instruction for the first video resource in the music cards, and update a piece of playback information of the first video resource; and
the video resource playback module is further configured to play a second video resource on the playback page in response to a playback switch instruction on the playback page, and keep a piece of playback information of the second video resource unchanged, where the playback information is used to update the display order of the music cards on the first search result page.

In an optional embodiment, the apparatus further includes a music resource display module;
the music resource display module is configured to display a plurality of music resources in the music card in a first arrangement manner in response to the type of the music card being a video type; and
the music resource display module is further configured to display a plurality of music resources in the music card in a second arrangement manner in response to the type of the music card being another type other than the video type.

In an optional embodiment, the display order of the music cards is determined based on a target point ranking model, and the target point ranking model is determined based on the type of a sample music card and features of a plurality of sample music resources in the sample music card.

In an optional embodiment, the apparatus further includes a model acquisition module, and the model acquisition module includes:
a sample information acquisition unit, configured to acquire information of a sample music card, where the information of the sample music card includes an interaction label, the type of the sample music card, and features of a plurality of sample music resources in the sample music card, the interaction label is used to represent whether the sample music resources in the sample music card have a piece of interaction information, and the features of the sample music resources include the relevance between the sample music resources and corresponding historical search information, and playback information of the sample music resources; and
a model training unit, configured to train an initial point ranking model based on the interaction label of the sample music card, the type of the sample music card, and the features of the plurality of sample music resources in the sample music card, to obtain the target point ranking model.

In an optional embodiment, the sample information acquisition unit includes:
a search result acquisition sub-module, configured to acquire a second search result page corresponding to a historical search instruction;
a music card determination sub-module, configured to determine a first music card displayed on the second search result page during a session process corresponding to the historical search instruction; and
a sample information acquisition sub-module, configured to determine the displayed first music card as the sample music card, to obtain the information of the sample music card.

In an optional embodiment, the sample information acquisition sub-module includes:
a music resource determination sub-unit, configured to determine the preset number of music resources ranking in top order in the sample music card; and
a sample feature acquisition sub-unit, configured to determine the preset number of music resources ranking in top order as the plurality of sample music resources in the sample music card, to obtain the features of the sample music resources.

In an optional embodiment, the sample information acquisition sub-module further includes:
a playback duration acquisition sub-unit, configured to acquire a playback duration of the first resource in response to determining that a first resource being played exists in the sample music card;
an effectiveness determination sub-unit, configured to determine interaction effectiveness of the first resource based on the playback duration; and
an interaction label determination sub-unit, configured to determine a label value of an interaction label of the sample music card based on the interaction effectiveness of the first resource.

In an optional embodiment, the apparatus further includes:
a card information acquisition module, configured to acquire a second music card displayed on the comprehensive search page, to obtain information of the second music card; and
a model update module, configured to update the target point ranking model based on the information of the second music card, to obtain an updated point ranking model.

Further functional descriptions of the above-mentioned modules and units are the same as those of the corresponding embodiments described above, which will not be repeated here.

The music information recommendation apparatus in the embodiments of the present disclosure is presented in the form of functional units, where the units refer to an application specific integrated circuit (ASIC), a processor and a memory that execute one or more pieces of software or fixed programs, and/or other devices that can provide the above-mentioned functions.

The embodiments of the present disclosure further provide an electronic device having the music information recommendation apparatus shown in FIG. 6.

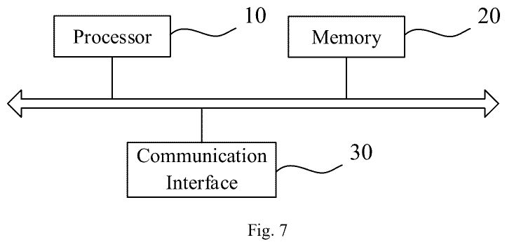

Referring to FIG. 7, FIG. 7 is a schematic diagram of a structure of an electronic device according to the embodiments of the present disclosure. As shown in FIG. 7, the electronic device includes one or more processors 10, one or more memories 20, and interfaces for connecting various components, and the interfaces include a high-speed interface and a low-speed interface. The various components are in communication connection with each other through different buses, and may be installed on a common motherboard or installed in other manners as required. The processor may process instructions executed within the electronic device, including instructions stored in or on the memory to display graphic information of a GUI on an external input/output apparatus (such as a display device coupled to an interface). In some optional embodiments, if required, a plurality of processors and/or a plurality of buses may be used together with a plurality of memories. Likewise, a plurality of electronic devices may be connected, and each device provides some necessary operations (for example, used as a server array, a group of blade servers, or a multiprocessor system). In FIG. 7, one processor 10 is used as an example.

The processor 10 may be a central processing unit, a network processor, or a combination thereof. The processor 10 may further include a hardware chip. The hardware chip may be an application specific integrated circuit, a programmable logic device, or a combination thereof. The programmable logic device may be a complex programmable logic device, a field programmable logic gate array, a generic array logic, or any combination thereof.

The memory 20 has instructions stored therein that can be executed by at least one processor 10, so that the at least one processor 10 performs the method illustrated in the above-mentioned embodiments.

The memory 20 may include a program storage area and a data storage area, where the program storage area may store an operating system and an application required for at least one function; and the data storage area may store data created according to the usage of the electronic device, etc. In addition, the memory 20 may include a high-speed random access memory, and may also include a non-transitory memory, such as at least one magnetic disk storage device, a flash memory device, or other non-transitory solid-state storage devices. In some optional embodiments, the memory 20 optionally includes a memory remotely provided relative to the processor 10, and the remote memory may be connected to the electronic device through a network. Examples of the above network include but are not limited to the Internet, an intranet, a local area network, a mobile communication network, and combinations thereof.

The memory 20 may include a volatile memory, such as a random access memory. The memory may also include a non-volatile memory, such as a flash memory, a hard disk, or a solid-state drive. The memory 20 may also include a combination of the above-mentioned types of memories.

The electronic device further includes a communication interface 30 for the electronic device to communicate with other devices or communication networks.

The embodiments of the present disclosure further provide a computer-readable storage medium. The method according to the embodiments of the present disclosure may be implemented in hardware or firmware, or may be implemented as computer code that can be recorded in a storage medium, or downloaded from a network and originally stored in a remote storage medium or a non-transitory machine-readable storage medium and that will be stored in a local storage medium, so that the method described herein may be processed by a such software stored in a storage medium using a general-purpose computer, a special-purpose processor, or programmable or special-purpose hardware. The storage medium may be a magnetic disk, an optical disk, a read-only memory, a random access memory, a flash memory, a hard disk, a solid-state drive, or the like. Further, the storage medium may also include a combination of the above-mentioned types of memories. It may be understood that a computer, a processor, a microprocessor controller, or programmable hardware includes a storage component that may store or receive software or computer code. When the software or computer code is accessed and executed by the computer, the processor, or the hardware, the method illustrated in the above-mentioned embodiments is implemented.

A part of the present disclosure may be applied as a computer program product, for example, computer program instructions, which, when executed by a computer, may invoke or provide the method and/or the technical solution according to the present disclosure through operations of the computer. Those skilled in the art should be able to understand that the presence forms of computer program instructions in a computer-readable medium include but are not limited to a source file, an executable file, an installation package file, and the like. Correspondingly, the manner in which the computer program instructions are executed by the computer includes but is not limited to: the computer directly executes the instructions, or the computer compiles the instructions and then executes a corresponding compiled program, or the computer reads and executes the instructions, or the computer reads and installs the instructions and then executes a corresponding installed program. Here, the computer-readable medium may be any available computer-readable storage medium or communication medium accessible by the computer.

Although the embodiments of the present disclosure have been described with reference to the drawings, those skilled in the art may make various modifications and variations without departing from the spirit and scope of the present disclosure, and such modifications and variations fall within the scope of the present disclosure.

1. A music information recommendation method, comprising:
displaying a comprehensive search page in response to a search instruction for a piece of music information; and
displaying a first search result page in response to an input instruction for search information on the comprehensive search page, wherein the first search result page is used to display a plurality of types of music cards, the music cards comprise a plurality of music resources, and a display order of the music cards is determined based on the types of the music cards and features of the plurality of music resources.

2. The method according to claim 1, wherein in response to the types of the music cards comprising a video type, the method further comprises:
playing a first video resource on a playback page in response to a playback instruction for the first video resource in the music cards, and updating a piece of playback information of the first video resource; and
playing a second video resource on the playback page in response to a playback switch instruction on the playback page, and keeping a piece of playback information of the second video resource unchanged, wherein the playback information is used to update the display order of the music cards on the first search result page.

3. The method according to claim 1, wherein in response to a type of a music card among the music cards being a video type, a plurality of music resources comprised in the music card are displayed in the music card in a first arrangement manner; and
in response to the type of the music card being another type other than the video type, the plurality of music resources comprised in the music card are displayed in the music card in a second arrangement manner.

4. The method according to claim 1, wherein the display order of the music cards is determined based on a target point ranking model, and the target point ranking model is determined based on a type of a sample music card and features of a plurality of sample music resources in the sample music card.

5. The method according to claim 4, wherein the target point ranking model is obtained based on the following steps:
acquiring information of the sample music card, wherein the information of the sample music card comprises an interaction label, the type of the sample music card, and the features of the plurality of sample music resources in the sample music card, wherein the interaction label is used to represent whether the sample music resources in the sample music card comprise a piece of interaction information, and wherein the features of the sample music resources comprise a relevance between the sample music resources and corresponding historical search information, and playback information of the sample music resources; and
training an initial point ranking model based on the interaction label of the sample music card, the type of the sample music card, and the features of the plurality of sample music resources in the sample music card, to obtain the target point ranking model.

6. The method according to claim 5, wherein the acquiring the information of the sample music card comprises:
acquiring a second search result page corresponding to a historical search instruction;
determining a first music card displayed on the second search result page during a session process corresponding to the historical search instruction; and
determining the displayed first music card as the sample music card, to obtain the information of the sample music card.

7. The method according to claim 6, wherein the acquiring the information of the sample music card further comprises:
determining a preset number of music resources ranking in top order in the sample music card; and
determining the preset number of music resources ranking in top order as the plurality of sample music resources in the sample music card, to obtain the features of the sample music resources.

8. The method according to claim 6, wherein the acquiring the information of the sample music card further comprises:
in response to determining that a first resource being played exists in the sample music card, acquiring a playback duration of the first resource;
determining interaction effectiveness of the first resource based on the playback duration; and
determining a label value of the interaction label of the sample music card based on the interaction effectiveness of the first resource.

9. The method according to claim 4, further comprising:
acquiring a second music card displayed on the comprehensive search page, to obtain information of the second music card; and
updating the target point ranking model based on the information of the second music card, to obtain an updated point ranking model.

10. An electronic device, comprising:
a memory and a processor, wherein the memory and the processor are in communication connection with each other, the memory stores computer instructions, and the processor is configured to execute the computer instructions to perform a music information recommendation method, and the music information recommendation method comprises:
displaying a comprehensive search page in response to a search instruction for a piece of music information; and
displaying a first search result page in response to an input instruction for search information on the comprehensive search page, wherein the first search result page is used to display a plurality of types of music cards, the music cards comprise a plurality of music resources, and a display order of the music cards is determined based on the types of the music cards and features of the plurality of music resources.

11. The electronic device according to claim 10, wherein in response to the types of the music cards comprising a video type, the music information recommendation method further comprises:
playing a first video resource on a playback page in response to a playback instruction for the first video resource in the music cards, and updating a piece of playback information of the first video resource; and
playing a second video resource on the playback page in response to a playback switch instruction on the playback page, and keeping a piece of playback information of the second video resource unchanged, wherein the playback information is used to update the display order of the music cards on the first search result page.

12. The electronic device according to claim 10, wherein in response to a type of a music card among the music cards being a video type, a plurality of music resources comprised in the music card are displayed in the music card in a first arrangement manner; and
in response to the type of the music card being another type other than the video type, the plurality of music resources comprised in the music card are displayed in the music card in a second arrangement manner.

13. The electronic device according to claim 10, wherein the display order of the music cards is determined based on a target point ranking model, and the target point ranking model is determined based on a type of a sample music card and features of a plurality of sample music resources in the sample music card.

14. The electronic device according to claim 13, wherein the target point ranking model is obtained based on the following steps:
acquiring information of the sample music card, wherein the information of the sample music card comprises an interaction label, the type of the sample music card, and the features of the plurality of sample music resources in the sample music card, wherein the interaction label is used to represent whether the sample music resources in the sample music card comprise a piece of interaction information, and wherein the features of the sample music resources comprise a relevance between the sample music resources and corresponding historical search information, and playback information of the sample music resources; and
training an initial point ranking model based on the interaction label of the sample music card, the type of the sample music card, and the features of the plurality of sample music resources in the sample music card, to obtain the target point ranking model.

15. The electronic device according to claim 14, wherein the acquiring the information of the sample music card comprises:
acquiring a second search result page corresponding to a historical search instruction;
determining a first music card displayed on the second search result page during a session process corresponding to the historical search instruction; and
determining the displayed first music card as the sample music card, to obtain the information of the sample music card.

16. The electronic device according to claim 15, wherein the acquiring the information of the sample music card further comprises:
determining a preset number of music resources ranking in top order in the sample music card; and
determining the preset number of music resources ranking in top order as the plurality of sample music resources in the sample music card, to obtain the features of the sample music resources.

17. The electronic device according to claim 15, wherein the acquiring the information of the sample music card further comprises:
in response to determining that a first resource being played exists in the sample music card, acquiring a playback duration of the first resource;
determining interaction effectiveness of the first resource based on the playback duration; and
determining a label value of the interaction label of the sample music card based on the interaction effectiveness of the first resource.

18. The electronic device according to claim 13, wherein the music information recommendation method further comprises:
acquiring a second music card displayed on the comprehensive search page, to obtain information of the second music card; and
updating the target point ranking model based on the information of the second music card, to obtain an updated point ranking model.

19. A non-transitory computer-readable storage medium, having computer instructions stored thereon, wherein the computer instructions are used to enable a computer to perform a music information recommendation method, and the music information recommendation method comprises:
displaying a comprehensive search page in response to a search instruction for a piece of music information; and
displaying a first search result page in response to an input instruction for search information on the comprehensive search page, wherein the first search result page is used to display a plurality of types of music cards, the music cards comprise a plurality of music resources, and a display order of the music cards is determined based on the types of the music cards and features of the plurality of music resources.

20. The storage medium according to claim 19, wherein in response to the types of the music cards comprising a video type, the music information recommendation method further comprises:
playing a first video resource on a playback page in response to a playback instruction for the first video resource in the music cards, and updating a piece of playback information of the first video resource; and
playing a second video resource on the playback page in response to a playback switch instruction on the playback page, and keeping a piece of playback information of the second video resource unchanged, wherein the playback information is used to update the display order of the music cards on the first search result page.
